(19) United States
(12) Patent Application Publication
(10) Pub. No.: US 2022/0114396 A1
(43) Pub. Date: Apr. 14, 2022

(54) METHODS, APPARATUSES, ELECTRONIC DEVICES AND STORAGE MEDIA FOR CONTROLLING IMAGE ACQUISITION

(71) Applicant: SENSETIME GROUP LIMITED, Shatin (CN)

(72) Inventors: Jiabin MA, Hong Kong (CN); Zheqi HE, Hong Kong (CN); Kun WANG, Hong Kong (CN); Xingyu ZENG, Hong Kong (CN)

(21) Appl. No.: 17/560,442

(22) Filed: Dec. 23, 2021

Related U.S. Application Data
(63) Continuation of application No. PCT/CN2020/097232, filed on Jun. 19, 2020.

(30) Foreign Application Priority Data
Jun. 28, 2019 (CN) 201910579147.3

(51) Int. Cl. G06K 9/62; G06V 20/40; G06V 10/82; G06V 10/98; G06V 20/56; G06N 3/04

(52) U.S. Cl. CPC G06K 9/6259; G06V 20/40; G06N 3/0454; G06V 10/98; G06V 20/588; G06V 10/82

(57) ABSTRACT

Method, apparatuses, systems, electronic devices, computer readable storage media, and computer program products for controlling image acquisition are provided. In one aspect, a method includes: providing a first image sample set to a first neural network; selecting one or more first hard samples from the first image sample set according to a processing result of the first neural network for each first image sample in the first image sample set; determining acquisition environment information of the one or more first hard samples based on the one or more first hard samples; and generating, according to the acquisition environment information, image acquisition control information for instruction of an acquisition of a second image sample set comprising one or more second hard samples.

### CROSS REFERENCE TO RELATED APPLICATION

This application is a continuation of International Application No. PCT/CN2020/097232 filed on Jun. 19, 2020, which claims the priority to Chinese Patent Application No. 201910579147.3, filed to the Chinese Intellectual Property Office on Jun. 28, 2019, both of which are incorporated herein by reference in their entireties.

### TECHNICAL FIELD

The present disclosure relates to computer vision technology, in particular to methods, apparatuses, electronic devices, computer readable storage media and computer products for controlling image acquisitions.

### BACKGROUND

A hard sample usually refers to an image sample that is, when used to train the neural network, easy to cause an error result of the neural network. Collecting hard samples and utilizing the hard samples to train the neural network is conductive to improving the performance of the neural network.

### SUMMARY

According to an aspect of the embodiments of the present disclosure, a method of controlling image acquisition is provided, including: providing a first image sample set to a first neural network; selecting one or more first hard samples from the first image sample set according to a processing result of the first neural network for each first image sample in the first image sample set; determining acquisition environment information of the one or more first hard samples based on the one or more first hard samples selected from the first image sample set; and generating, according to the acquisition environment information, image acquisition control information for instruction of an acquisition of a second image sample set including one or more second hard samples.

In an embodiments of the present disclosure, the first image sample set includes a first image sample without label information.

In an embodiments of the present disclosure, selecting the one or more first hard samples from the first image sample set according to the processing result of the first neural network for each first image sample in the first image sample includes: detecting whether the processing result of the first neural network for each first image sample in the first image sample set is incorrect; determining a first hard sample according to a first image sample corresponding to an incorrect processing result of the first neural network for the first image sample.

In an embodiments of the present disclosure, the first image sample set includes a plurality of video frame samples consecutive in a time sequence, and where detecting whether the processing result of the first neural network for each first image sample in the first image sample set is incorrect includes: performing a target object continuity detection on respective target object detection results output by the first neural network for the plurality of video frame samples, and detecting whether a processing result of the first neural network for a video frame sample is incorrect by determining whether the respective target object detection result corresponding to the video frame sample fails to meet a preset continuity requirement.

In an embodiments of the present disclosure, the method further includes: providing the first image sample set to a second neural network, where detecting whether the processing result of the first neural network for each first image sample in the first image sample set is incorrect includes: determining a difference between a first processing result of the first neural network for the first image sample and a second processing result of the second neural network for the first image sample; and detecting whether the first processing result of the first neural network for the first image sample is incorrect by determining that the difference fails to meet a preset difference requirement.

In an embodiments of the present disclosure, determining the first hard sample according to the first image sample corresponding to the incorrect processing result of the first neural network for the first image sample includes: obtaining an error type of the incorrect processing result; and in response to determining that the error type of the incorrect processing result is a neural network processing error, determining the first image sample as the first hard sample.

In an embodiments of the present disclosure, the first neural network is configured to detect a target object in the first image sample, and where the computer-implemented method further includes: in response to determining that the error type of the incorrect processing result indicates that a target object bounding box obtained by the first neural network performing a detection on the first image sample is incorrect, adjusting a module that is included in the first neural network and configured to detect the target object bounding box.

In an embodiments of the present disclosure, the method further includes: in response to determining that the error type of the incorrect processing result is associated with a factor of camera device, sending promotion information of changing the camera device.

In an embodiments of the present disclosure, the acquisition environment information includes at least one of: road section information, weather information, or light intensity information.

In an embodiments of the present disclosure, the acquisition environment information includes the road section information, and where generating the image acquisition control information according to the acquisition environment information includes: determining an acquisition road section matching the one or more first hard samples based on the road section information; generating a data acquisition path with the determined acquisition road section; and generating the image acquisition control information including the data acquisition path for instruction of a camera device to acquire the second image set according to the data acquisition path

In an embodiments of the present disclosure, the method further includes: adding the one or more first hard samples to a training sample set; obtaining an adjusted first neural network by training the first neural network with the training sample set.

In an embodiments of the present disclosure, where each of the one or more first hard samples is with corresponding label information, and where obtaining the adjusted first neural network by training the first neural network with the training sample set includes: providing the one or more first hard samples in the training sample set to the first neural network; and obtaining the adjusted first neural network by adjusting at least one parameter of the first neural network according to a difference between a processing result of the first neural network for each of the one or more first hard samples and the corresponding label information.

In an embodiments of the present disclosure, the method further includes: obtaining the second image sample set; providing the second image sample set to the adjusted first neural network; selecting the one or more second hard samples from the second image sample set according to a processing result of the adjusted first neural network for each second image sample in the second image sample set.

According to another aspect of the embodiments of the present disclosure, an apparatus is provided, including: at least one processor; and one or more memories coupled to the at least one processor and storing programming instructions for execution by the at least one processor to implement the method of controlling image acquisition according to any one of the embodiments of the present disclosure.

According to another aspect of the embodiments of the present disclosure, a computer readable storage medium is provided, storing a computer program thereon which is executable by a processor to implement the method of controlling image acquisition according to any one of the embodiments of the present disclosure.

According to another aspect of the embodiments of the present disclosure, a computer program is provided, including computer instructions, where the computer instructions are executable by a processor to implement the method of controlling image acquisition according to any one of the embodiments of the present disclosure.

Based on the method, apparatus, electronic device and computer readable storage medium for controlling image acquisition provided in the present disclosure, by inputting a first image sample set to a first neural network, a first hard sample is selected from the first image sample set according to a processing result of the first neural network for each first image sample in the first image sample set, so that acquisition environment information of the first hard sample is determined and image acquisition control information can be generated according to the acquisition environment information. Under the instruction of the image acquisition control information generated according to the present disclosure, a second image sample set including one or more second hard samples can be obtained. In this way, based on the obtained first hard sample, a way for acquiring second hard sample(s) can be determined quickly and conveniently, and the acquired second hard sample is related to the first hard sample to some extend, thereby improving an acquisition efficiency for related hard samples and acquiring more hard samples effectively.

In addition, the obtained hard samples can be used to adjust and optimize the neural network so to improve the processing performance of the neural network.

Furthermore, the first hard sample can be selected based on the processing result of the neural network for the first image sample without labeling the first image sample, which facilitates to decrease the cost of manual labeling and improve the processing efficiency of determining hard samples.

Some embodiments of the present disclosure will be further described in detail hereinafter through the accompanying drawings and embodiments.

### BRIEF DESCRIPTION OF THE DRAWINGS

Through the following detailed description of some embodiments of the present disclosure with reference to the accompanying drawings, the present disclosure can be understood more clearly, in which:

FIG. 1 is a flowchart of a method of controlling image acquisition according to some embodiments of the present disclosure;

FIG. 2 illustrates a video frame sample of error detection according to some embodiments of the present disclosure;

FIG. 3 is a flowchart of a neural network training method according to some embodiments of the present disclosure;

FIG. 4 is a block diagram of an image acquisition control apparatus according to some embodiments of the present disclosure;

FIG. 5 is a block diagram of an electronic device according to some embodiments of the present disclosure.

### DETAILED DESCRIPTION OF THE EMBODIMENTS

Various exemplary embodiments of the present disclosure will now be described in detail with reference to the accompanying drawings. It should be noted that, relative arrangements of components and steps, numerical expressions and numerical values set forth in these embodiments cannot be construed to be a limit to the scope of the present disclosure, unless specifically stated otherwise.

Meanwhile, it should be understood that, for ease of description, sizes of various parts illustrated in the drawings are not drawn in accordance with actual scales.

The following description of the embodiments is only illustrative, and should not be construed as a limit to the present disclosure or its application or usage in any manner.

Techniques, methods, and equipment known to one of ordinary skill in the relevant arts may not be discussed in detail, and if appropriately, the techniques, the methods, and the equipment should be considered as part of the specification.

It should be understood that be noted that similar reference signs and letters in the following drawings indicate similar items, therefore, once an item is defined in one drawing, it does not need to be further discussed in subsequent drawings.

The embodiments of the present disclosure may be applied to electronic devices such as terminal devices, computer systems, and servers, which may operate with numerous other general-purpose or special-purpose incorrect computing system environments or configurations. Examples of well-known terminal devices, computing systems, environments, and/or configurations suitable for use together with the electronic devices such as terminal devices, computer systems, and servers include, but are not limited to, personal computer systems, server computer systems, thin clients, thick clients, handheld or laptop devices, microprocessor-based systems, set top boxes, programmable consumer electronics, network personal computers, small computer systems, large computer systems, distributed cloud computing technology environments that include any one of the systems, and the like.

The electronic devices such as terminal devices, computer systems, and servers may be described in the general context of computer system executable instructions (such as, program modules) executed by the computer systems. Typically, a program module may include a routine, a program, an object program, a component, logic, data structures, etc., which perform a specific task or implement a specific abstract data type. The computer system/server can be implemented in a distributed cloud computing environment, in which a task is executed by a remote processing device linked through communication networks. In a distributed cloud computing environment, a program module may be located on storage media of a local or remote computing system which includes a storage device.

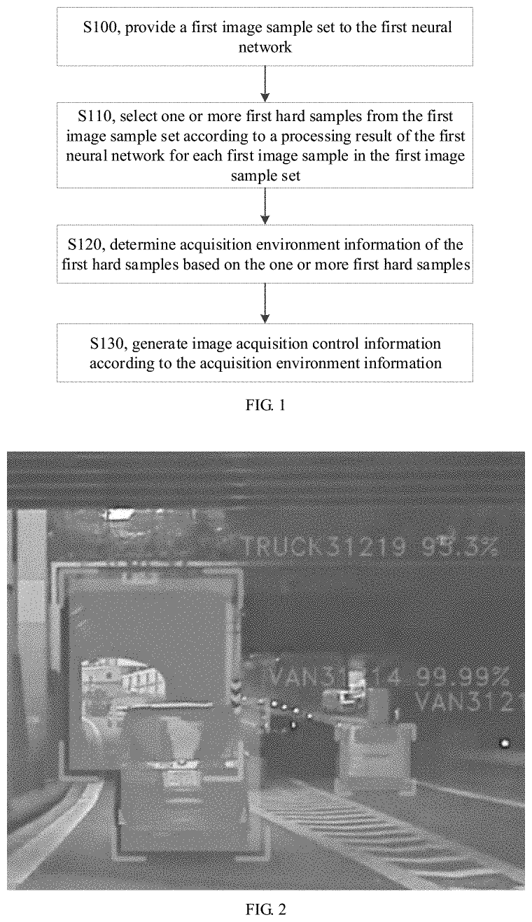

FIG. 1 is a flowchart of a method of controlling image acquisition according to some embodiments of the present disclosure. The method can be performed by an electronic device as discussed above. As shown in FIG. 1, the method of this embodiment includes steps: S100, S110, S120, and S130. The steps are described in detail below.

At step S100: a first image sample set is provided to a first neural network.

The first image sample set in the present disclosure includes but is not limited to: a plurality of photos taken by a camera device, or a plurality of video frames consecutive in time sequence taken by the camera device. For example, a plurality of photos or video frames taken by the camera set on a moving object. The moving object includes but are not limited to: a vehicle, a robot, a manipulator, or a sliding rail. In some embodiments, the camera device in the present disclosure may include, but is not limited to, an infrared (IR) camera, or a Red Green Blue (RGB) camera, etc. In some embodiments, in a case that the first image sample is a video frame, the embodiments of the present disclosure may input a plurality of first image samples into a first neural network according to a relationship of the video frames in a time sequence.

In some embodiments, the first neural network in the present disclosure includes, but is not limited to: a first neural network for detecting a target object. The first neural network may be a neural network capable of, for a first image sample in the input first image sample set, outputting position information of the target object involved in the first image sample and classification information of the target object. In some embodiments, the first neural network may be a neural network using a structure of residual neural network and faster convolutional neural network (Resnet+FasterRCNN), for example, a neural network using a Resnet50+FasterRCNN structure. The position information is used to indicate an image area where the target object is located in the first image sample. The position information includes, but is not limited to: coordinates of two vertices located on the diagonal of a bounding box of the target object. The classification information is used to indicate the category to which the target object belongs. This category includes but is not limited to: pedestrian, vehicle, tree, building, traffic sign, etc.

In an embodiment, the first image sample set in the present disclosure may include: a first image sample without label information. The label information can be information labeled with object in the first image sample, e.g., as illustrated in FIG. 2. When the first image samples do not have the label information, in the embodiments of the present disclosure, a first hard sample may be selected from a plurality of first image samples that do not have the label information. Therefore, compared to the implementation of testing the first image sample with the label information in the first image sample set through the first neural network and determining the first hard sample according to a test result, the embodiments of the present disclosure do not need to label the plurality of first image samples in the first image sample set respectively, which helps to reduce a workload of labeling, thereby helping to reduce the cost of obtaining the hard sample, and improving the efficiency of obtaining the hard sample.

At step S110: one or more first hard samples are selected from the first image sample set according to a processing result of the first neural network for each first image sample in the first image sample set.

In an embodiment, the present disclosure can detect whether the processing result of the first neural network for each first image sample in the first image sample set is correct, so that the first image sample corresponding to the incorrect processing result can be obtained. the present disclosure can determine the one or more first hard samples based on the detected first image sample corresponding to the incorrect output result.

For example, the present disclosure may directly use the detected first image sample corresponding to the incorrect processing result as the first hard sample. The present disclosure directly uses a detected first image sample corresponding to the incorrect processing result as the first hard sample, and can select a first hard sample from the first image samples without labeling each of the first image samples, which helps reduce the cost of obtaining hard samples.

It should be understood that the first hard sample and the second hard sample described below may be collectively referred to as the hard sample in the present disclosure. For example, a hard sample may be understood as an image sample that is hard to obtain through random acquisition during an image sample acquisition stage. In the training process of the first neural network, such hard samples can easily cause errors in the processing result of the first neural network and affect the processing performance of the first neural network. Therefore, in the training process of the first neural network, using a training sample set having a certain amount of hard samples to train the first neural network helps to improve the processing performance of the trained first neural network.

For another example, in the present disclosure, according to an error type of the detected first image sample corresponding to the incorrect processing result, a first hard sample may be selected from the first image samples respectively corresponding to a plurality of incorrect processing results. In the present disclosure, by selecting the first hard sample from the first image samples respectively corresponding to the plurality of incorrect processing results through the error type, the first hard sample can be selected from the first image samples without labeling each of the first image samples, so that the first hard sample can be selected more accurately from the first image sample set, thereby helping to reduce the cost of obtaining hard samples and improving the accuracy of obtaining the hard samples.

In an embodiment, the present disclosure may have multiple implementation manners for detecting whether the processing result of the first neural network for each first image sample in the first image sample set is correct. Two specific examples are shown below:

As an optional example, in the case where the first image sample set includes a plurality of video frame samples consecutive in time sequence, the present disclosure may perform a target object continuity detection on target object detection results output by the first neural network for a plurality of video frame samples, and take a target object detection result that does not meet a preset continuity requirement as the incorrect processing result. Then, the first hard sample can be determined based on the first image sample corresponding to the incorrect processing result.

The target object continuity detection in the present disclosure may also be referred to as a target object flash detection. In other words, since the plurality of video frame samples are continuous in time sequence, an existence of the target object in the plurality of the video frame samples is usually continuous, for example, the target object exists in all the ten video frame samples that are consecutive in time sequence, but the location may varies. If a target object only appears in one video frame sample, but does not appear in other adjacent video frame samples, it can be considered that the target object flashes in the video frame samples, and it is very likely that the target object does not exist in the video frame sample. However, due to an incorrect identification of the first neural network, it is considered that the target object exists in the video frame sample. By performing the target object flash detection in the present disclosure, a video frame sample in which the target object flashes can be quickly selected from the plurality of video frame samples, so that the first hard sample can be selected from the plurality of video frame samples without labeling the plurality of video frame samples.

As another example, the above-mentioned first neural network can be deployed in a device such as a computer, a vehicle device, or a mobile phone. The deployed first neural network generally has a relatively simple network structure, for example, the number of convolutional layers and pooling layers is small. The present disclosure may provide a second neural network, where the network complexity of the second neural network is higher than that of the first neural network, for example, including more deep convolutional layers, pooling layers, etc. In this case, the accuracy of processing the first image sample by the second neural network may be higher than the accuracy of processing the first image sample by the first neural network. Therefore, the present disclosure can provide the first image samples in the first image sample set to the first neural network and the second neural network, respectively. Since the accuracy of the second neural network is higher than that of the first neural network, a processing result of the second neural network for the first image sample can be used as a standard to check the processing result of the first neural network for the first image sample, so that the differences between processing results of the second neural network for a plurality of first image samples and processing results of the first neural network for the plurality first image samples can be obtained. The present disclosure may use the processing result corresponding to the difference that does not meet the preset difference requirement as an incorrect processing result. Then, the first hard sample can be determined based on the first image sample corresponding to the incorrect processing result.

Optionally, the difference of the processing results in the present disclosure may include, but is not limited to at least one of the following: a difference in the number of target objects, a difference in the positions of the target object, or a category to which the target object belongs.

In a first example, for any first image sample, the number of target objects detected by the second neural network for the first image sample can be obtained, and the number of target objects detected by the first neural network for the first image sample can be obtained, if the numbers of target objects are different, it is considered that the difference in the number does not meet the preset difference requirement, and the first image sample can be used as the first image sample corresponding to the incorrect processing result.

In a second example, for any first image sample, the position information (hereinafter referred to as the first position information) of each target object detected by the second neural network for the first image sample can be obtained, and the position information (hereinafter referred to as the second position information) of each target object detected by the first neural network for the first image sample can be obtained. For any first position information, the distance between the first position information and each second position information is calculated, and the minimum distance is selected. If the minimum distance is not less than a preset minimum distance, the difference in positions is considered to not meet the preset difference requirement, and the first image sample can be used as the first image sample corresponding to the incorrect processing result.

In a third example, for any first image sample, the category to which each target object detected by the second neural network for the first image sample belongs (hereinafter referred to as the first category) can be obtained, and the category to which each target object detected by the first neural network for the first image sample (hereinafter referred to as the second category) can be obtained. For any second category, determine whether there is a same category as the second category in the set of first categories. If the same category does not exist, it is considered that the category difference does not meet the preset difference requirement and the first image sample can be used as the first image sample corresponding to the incorrect processing result. For example, for an intermodal container in the first image sample, the second neural network can accurately identify the category of the bounding box corresponding to the intermodal container as an intermodal container. However, the first neural network may identify the category of the bounding box corresponding to the intermodal container as a truck, the first image sample can be determined as the first image sample corresponding to the incorrect processing result by using the above determining method.

For example, for a video frame sample, the first neural network detects a columnar isolated object in the video frame sample as a pedestrian, which does not match the isolated object detected by the second neural network. Therefore, the video frame sample can be used as the first hard sample.

For another example, for a video frame sample shown in FIG. 2, the first neural network detects the tunnel entrance in the video frame sample as a truck, which does not match the tunnel entrance detected by the second neural network. Therefore, the video frame sample is used as a first hard sample.

Optionally, the above three examples can be used in any combination.

For example, for any first image sample, a number of target objects detected by the second neural network for the first image sample and first position information of each target object can be obtained, and a number of target objects detected by the first neural network for the first image sample and second position information of each target object can be obtained. If the two numbers are not the same, it is considered that the number difference does not meet the preset difference requirement. In the present disclosure, the first image sample may be used as the first image sample corresponding to an incorrect processing result. If the two numbers are the same, for any first position information, a distance between the first position information and each second position information can be calculated, and a minimum distance may be selected therefrom. If the minimum distance is not less than a preset minimum distance, it is determined that the distance difference does not meet the preset difference requirement, and the first image sample may be used as the first image sample corresponding to an incorrect processing result.

For another example, for any first image sample, the number of target objects detected by the second neural network for the first image sample, the first position information and the first category of each target object can be obtained, and the number of target objects detected by the first neural network for the first image sample, the second position information and the second category of each target object can be obtained. If the two numbers are not the same, it is considered that the number difference does not meet the preset difference requirement. In the present disclosure, the first image sample may be used as the first image sample corresponding to an incorrect processing result. If the two numbers are the same, for any first position information, a distance between the first position information and each second position information can be calculated, and a minimum distance may be selected therefrom. If the minimum distance is not less than a preset minimum distance, it is determined that the distance difference does not meet the preset difference requirement, and the first image sample may be used as the first image sample corresponding to an incorrect processing result. If the minimum distance is less than the preset minimum distance, it can be determined that whether the first category of the target object corresponding to the first location information and the second category of the target object corresponding to the second location information associated with the minimum distance are the same. If they are not the same, it is determined that the category difference does not meet the preset difference requirement, and the first image sample may be used as the first image sample corresponding to an incorrect processing result.

The examples of mutual combination will not be explained one by one here. The present disclosure determines whether the processing result of the first neural network for the first image sample is correct by using the processing result of the second neural network for the first image sample as the standard, which is beneficial to quickly and accurately select the first image sample corresponding to the incorrect processing result from the first image sample set, so that the first hard sample can be selected from the first image sample set quickly and accurately. In addition, when using the second neural network, the first image sample set in the present disclosure may include multiple images that do not have a relationship in time sequence, or may include multiple video frame samples that have a relationship in time sequence, thereby enlarging a scope of applying the acquisition for hard samples.

In an optional example, an example of selecting the first hard sample from the first image samples corresponding to the incorrect processing results according to error types of the detected first image samples corresponding to the incorrect processing results can be:

First, obtaining an error type of an incorrect processing result, and then taking the first image sample corresponding to the processing result of which the error type is the neural network processing error as the first hard sample. In addition to the error type of neural network processing error, in the present disclosure, multiple error types may be included. For example, a target object bounding box obtained by the first neural network detecting the first image sample is incorrect or a factor of camera device, etc. This is not limited in the present disclosure.

Optionally, when it is determined that the position of the target object in the first image sample is stagnant, it can be determined that the corresponding error type is that the bounding box of the target object obtained by the first neural network detecting the first image sample is incorrect. A position stagnation phenomenon may refer to that the target object has left a viewing angle range of the camera device, but the target object is still detected in the corresponding first image sample. In the present disclosure, a module for detecting the target object bounding box included in the first neural network can be adjusted when it is determined that a bounding box tracking algorithm error exists in the first image sample, which is beneficial to improve the performance of the bounding box tracking by the first neural network and helps to avoid that a first image sample is mistakenly regarded as a first hard sample, thereby helping to improve the accuracy of obtaining the first hard sample.

Optionally, in the present disclosure, promotion information for adjusting the camera device may be sent when it is determined that the first image sample has an error type of a factor of camera device. For example, if a color of the target object involved in the first image sample is distorted due to the camera device, it may be prompted to replace the camera device. For example, if a color of a traffic light involved in the video frame sample captured by the camera device is distorted (for example, the color of the red light is like the yellow light, etc.), it is prompted to replace the camera device. In the present disclosure, it can be determined that whether there is a color distortion phenomenon by detecting a gray value of the pixel at the corresponding position in the video frame sample or the like. As another example, if the color of the target object involved the first image sample is distorted due to reasons such as too strong external light (such as the color distortion of the traffic light involved the video frame sample, etc., the present disclosure can detect the gray value of all pixels of the video frame sample to determine whether there are reasons such as too strong external light), the conditions for determining the target object can be further improved, for example, the current color of the traffic light can be determined according to a position of the lighting.

In the present disclosure, corresponding remedial measures are implemented when it is determined that the first image sample has an error type of the factor of the camera device, which is beneficial to improve the target object detection performance of the neural network, and helps to avoid that a first image sample is mistakenly regarded as a first hard sample, thereby helping to improve the accuracy of obtaining the first hard sample.

In addition, the present disclosure can determine whether the first image sample has an error type that is complicated and difficult to determine based on a consistency of multiple ground landmarks detected in the first image sample. For example, the first neural network takes multiple arrows in different directions (such as leftward, rightward, and forward arrows) on the ground shown in a video frame sample are all mistakenly detected as forward arrows. Therefore, it can be determined that first image sample has an error type that is complicated and difficult. In the present disclosure, a process of identifying the arrow direction in the first image sample may be added to the first neural network to deal with complex situations. The first neural network can also be repeatedly trained by using similar first hard samples, so that the first neural network can accurately determine the directions of the arrows.

In an optional example, the first hard sample may be added to the training sample set, and then the training sample set including the first hard sample may be used to train the first neural network to obtain an adjusted first neural network.

Exemplarily, the first hard sample currently obtained may be labeled, and the labeled first hard sample may be added to the training sample set for optimizing the first neural network.

In one embodiment, the first hard sample with label information in the training sample set may be provided to the first neural network, and according to a difference between the processing result of the first neural network for the first hard sample with label information and corresponding label information, a parameter of the first neural network is adjusted to obtain an adjusted first neural network.

In another embodiment, after pre-training the neural network with the image samples in the sample data set, the first hard sample with the labeled information in the training sample set can be used to further train the first neural network, so that the parameter of the first neural network can be further optimized. For another example, in the process of pre-training the first neural network, a certain proportion of first hard samples is used. After the pre-training is completed, the first hard sample with label information in the training sample set is used to further train the first neural network to further optimize the parameter of the first neural network to obtain the adjusted first neural network.

Since the first image sample in the present disclosure may not include the label information, the present disclosure may only label a first hard sample selected from the first image sample set, thereby avoiding the need to label each first image sample in the first image sample set and then provide the labeled first image sample to the first neural network, and determine the hard sample in the first image sample set according to the processing result and the label information output by the first neural network. In the present disclosure, the amount of labeling work performed to find hard samples can be greatly reduced. Therefore, the present disclosure is beneficial to reducing the cost of obtaining hard samples and improving the efficiency of obtaining hard samples.

At step S120, acquisition environment information of the one or more first hard samples is determined based on the first hard sample.

In an optional example, the acquisition environment information in the present disclosure includes at least one of road section information, weather information, or light intensity information. The road section information may refer to road information where the camera device is located when the first hard sample is obtained. The weather information may refer to the weather conditions when the camera device obtains the first hard sample, for example, sunny, cloudy, raining, snowing, season or temperature, etc. The light intensity information may refer to a phenomena such as backlighting or strong light exposure caused by factors such as the shooting time and the shooting position when the camera device obtains the first hard sample.

In an optional example, the present disclosure may determine the acquisition environment information of the first hard sample according to note information of the video or the note information of the photo. The present disclosure may also adopt a manual identification method to determine the acquisition environment information of the first hard sample. The present disclosure does not limit the specific implementation of determining the acquisition environment information of the first hard sample.

At step S130, according to the acquisition environment information, image acquisition control information is generated, and the image acquisition control information is to instruct an acquisition of a second image sample set including one or more second hard samples.

The image acquisition control information may include, but is not limited to, at least one of: a data acquisition path generated based on the road section information, a data acquisition weather environment generated based on the weather information, or a data acquisition light environment generated based on the light intensity information.

In an optional example, in the case that the acquisition environment information includes the road section information, the method may include: first performing a planning operation for a data acquisition path according to the road section information to which the first hard sample belongs, thereby forming the data acquisition path. If there are a plurality of first hard samples, the data acquisition path formed in the present disclosure may include the road sections to which the plurality of first hard samples belong. For example, in the present disclosure, all road sections to which the first hard samples belong can be provided as input to a map navigation application, so that a route can be output by the map navigation application, and the path includes road sections to which the first hard samples belong. This path is the data acquisition path.

Optionally, in the present disclosure, a data acquisition vehicle having a camera device may drive along the data acquisition path and shoot during the driving process, such as taking photos or videos, to perform the data acquisition operation. In addition, when performing the data acquisition operation, the weather and light intensity in the acquisition environment information of the first hard samples can be considered to determine the weather environment, light environment, etc. for performing the data acquisition operation. For example, in the morning on a sunny day, the data acquisition vehicle drives along the data acquisition path and shoots, so as to obtain multiple photos or videos of the street scene taken against the sunlight with a low irradiation angle. For another example, in the evening on a cloudy day, the data acquisition vehicle drives along the data acquisition path and shoots, so as to obtain multiple photos or videos of the street scene in dim light.

In an optional example, the second image sample set (such as multiple photos or videos) acquired through the image acquisition control information may be obtained in the present disclosure. In one embodiment, after the second image sample set is obtained, the second image sample set may be provided to the adjusted first neural network, and then according to the processing result of the adjusted first neural network for each second image sample in the second image sample set, a second hard sample is selected from the second image sample set.

In the present disclosure, the second hard sample obtained at this time can be used to execute the above steps S100-S130 again, where the first neural network used in the process of executing S100-S130 can be an adjusted first neural network obtained by training with a training sample set including the first hard sample currently obtained. The method provided by the present disclosure can be executed iteratively, so that the second hard sample can be obtained from the second image sample set, and then a third hard sample can be obtained from a third image sample set again, and so on. After repeating the above steps S100-S130 for multiple times (that is, after multiple iterations of the method of the present disclosure), the present disclosure can achieve rapid accumulation of hard samples.

Since the present disclosure executes the data acquisition operation (such as planning the data acquisition path according to the road section to which the first hard sample belongs) according to the image acquisition control information determined by the acquisition environment information of the first hard sample currently obtained, the present disclosure has more chances of obtaining photos or video frames similar with the first hard sample, that is, the second image sample set obtained has a higher probability of including a second hard sample, that is, the present disclosure can reproduce similar hard samples. Therefore, the present disclosure is beneficial to quickly accumulate hard samples, and thereby reducing the cost of obtaining hard samples and improving the efficiency of obtaining hard samples.

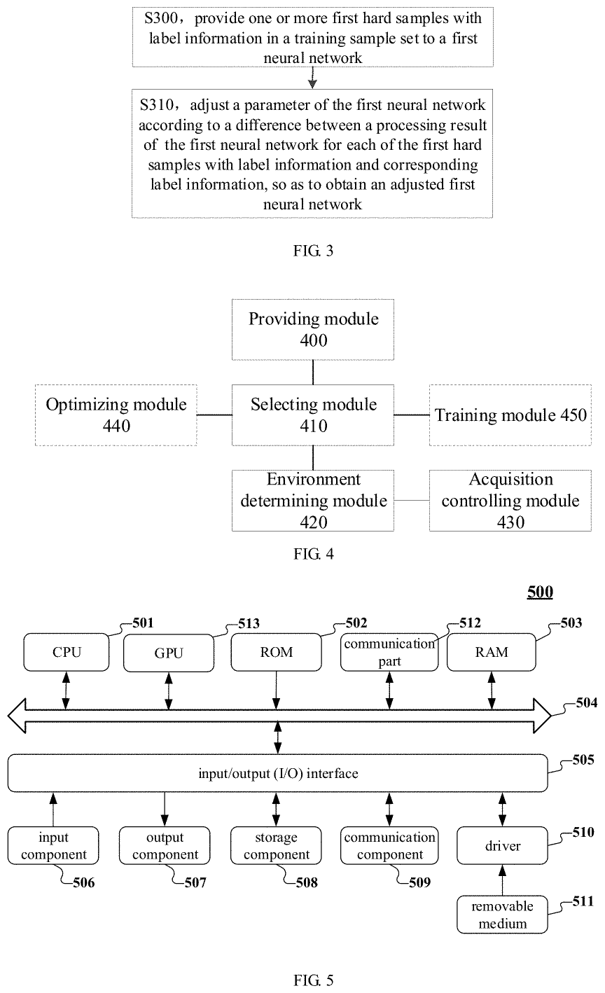

FIG. 3 is a flowchart of a neural network training method according to some embodiments of the present disclosure. The neural network takes the first neural network as an example. As shown in FIG. 3, the method includes steps S300 and S310. The steps are described in detail below.

At step S300: one or more first hard samples with label information in a training sample set are provided to a first neural network.

Optionally, the first hard sample in the training sample set in the present disclosure includes: the first hard sample obtained by using the steps recorded in the foregoing method implementation. First hard samples in the training sample set all have label information.

Optionally, the first neural network in the present disclosure may be a neural network after pre-training. In addition, the first neural network may be a neural network used to detect a target object, for example, a neural network used to detect a position and category of the target object.

At step S310: a parameter of the first neural network is adjusted according to a difference between a processing result of the first neural network for each of the first hard samples with label information and corresponding label information, so as to obtain an adjusted first neural network.

Optionally, the present disclosure may determine a loss according to the output of the first neural network for multiple hard samples and the label information of the multiple first hard samples, and adjust the parameter of the first neural network according to the loss. The parameter in the present disclosure may include, but are not limited to: a convolution kernel parameter and/or a matrix weight.

In an optional example, this training process ends when the training for the first neural network reaches a preset iteration condition. The preset iteration condition in the present disclosure may include: the difference between the output of the first neural network for the first hard sample and the label information of the first hard sample meets the preset difference requirement. In the case that the difference meets the preset difference requirement, the training of the first neural network is successfully completed this time. The preset iteration condition in the present disclosure may also include: a number of first hard samples used for training the first neural network reaches a preset number requirement, and the like. The first neural network successfully trained can be used to detect the target object.

FIG. 4 is a block diagram of an image acquisition control apparatus according to some embodiments of the present disclosure. The apparatus shown in FIG. 4 includes: a providing module 400, a selecting module 410, an environment determining module 420 and an acquisition controlling module 430. Optionally, the apparatus may include: an optimization module 440 and a training module 450. The following describes the modules in detail.

The providing module 400 is configured to provide a first image sample set to a first neural network; The first image sample set may include a first image sample without label information. For specific operations performed by the providing module 400, refer to the description of S100 in the foregoing method implementation manner.

The selecting module 410 is configured to select one or more first hard samples from the first image sample set according to a processing result of the first neural network for each first image sample in the first image sample. Optionally, the selecting module 410 may include: a first submodule and a second submodule. The first submodule is configured to detect whether the processing result of the first neural network for each first image sample in the first image sample set is correct or not. For example, the first submodule may be configured to, in a case that the first image sample set includes a plurality of video frame samples consecutive in time sequence; performing a target object continuity detection on target object detection results output by the first neural network for the plurality of video frame samples respectively, and take one or more of the target object detection results that do not meet a preset continuity requirement as the incorrect processing result. For another example, in a case that the providing module 400 provides the first image sample to the second neural network, the first submodule may determine a difference between a second processing result of the second neural network for the first image sample and a first processing result of the first neural network for the first image sample; and in response to that the difference does not meet a preset difference requirement, take the first processing result as the incorrect processing result. The second submodule is configured to according to a first image sample which is detected as corresponding to an incorrect processing result, determine the first hard sample. For example, the second submodule may obtain an error type of the incorrect processing result; and take the first image sample corresponding to the processing result of which the error type is a neural network processing error as the first hard sample. For specific operations performed by the screening module 410 and the submodules included therein, reference may be made to the description of S110 in the foregoing method implementation.

The environment determining module 420, configured to determine acquisition environment information of the first hard sample based on the first hard sample. The acquisition environment information includes at least one of: road section information, weather information, or light intensity information. For specific operations performed by the environment determining module 420, reference may be made to the description of S120 in the foregoing method implementation manner.

The acquisition controlling module 430 is configured to generate image acquisition control information according to the acquisition environment information, where the image acquisition control information is to instructs the acquisition of a second image sample set including one or more second hard samples. Optionally, when the acquisition environment information includes the road section information, the acquisition controlling module 430 may determine an acquisition road section matching the first hard samples based on the road section information; generate a data acquisition path with the determined acquisition road section, where the data acquisition path so to instruct a camera device to acquire the second image set according to the data acquisition path.

In a case that the first neural network is used to detect a target object in the first image sample, the optimizing module 440, configured to in response to that the error type of the incorrect processing result indicates that a target object bounding box obtained by the first neural network performing a detection on the first image sample is incorrect, adjust a module included in the first neural network for detecting the target object bounding box. In response to that the error type of the incorrect processing result is related to a factor of camera device, the second submodule may send promotion information of changing the camera device. For specific operations performed by the optimizing module 440, reference may be made to related descriptions in the foregoing method implementation manners.

The training module 450 is configured to add the one or more first hard samples to a training sample set; and obtain an adjusted first neural network by training the first neural network with the training sample set. Further, the training module 450 may label the first hard sample and add one or more first hard samples with label information to the training sample set; provide the one or more first hard samples with the label information in the training sample set to the first neural network; and adjust a parameter of the first neural network according to a difference between a processing result of the first neural network for each of the first hard samples with label information and corresponding label information, so as to obtain the adjusted first neural network. For specific operations performed by the training module 450, reference may be made to the related description of FIG. 3 in the foregoing method implementation.

In the present disclosure, the providing module 400 may also obtain a second image sample set and provide the second image sample set to the adjusted first neural network. The selection module 410 may select one or more second hard samples from the second image sample set according to a processing result of the adjusted first neural network for each second image sample in the second image sample set. For specific operations performed by the acquisition control module 430, refer to the description of S130 in the foregoing method implementation manner.

FIG. 5 shows an exemplary electronic device 500 for implementing the present disclosure. The electronic device 500 may be a control system/electronic system configured in a car, a mobile terminal (for example, a smart mobile phone, etc.), a personal computer (PC, for example, a desktop computer or a laptop, etc.), a tablet computer, a server, and the like. In in FIG. 5, the electronic device 500 includes one or more processors, a communication component, etc. The one or more processors include one or more central processing units (CPU) 501, and/or one or more images Processor (GPU) 513. The processors can perform various appropriate actions and processing according to executable instructions stored in read-only memory (ROM) 502 or executable instructions loaded from storage component 508 to random access memory (RAM) 503. The communication part 512 may include but is not limited to a network card, and the network card may include but is not limited to an IB (Infiniband) network card. The processor can communicate with the ROM 502 and/or the RAM 503 to execute executable instructions, and is connected to the communication part 512 through the bus 504, and communicates with other target devices through the communication part 512, thereby completing the corresponding steps in the present disclosure.

For the operations performed by the foregoing instructions, reference may be made to the relevant descriptions in the foregoing method embodiments, and detailed descriptions are omitted here. In addition, the RAM 503 can further store various programs and data required for apparatus operation. CPU 501, ROM 502, and the RAM 503 are coupled with each other via the bus 504.

In a case that there is a RAM 503, ROM 502 is an optional module. The RAM 503 is to store executable instructions, or write executable instructions into the ROM 502 when running, and the executable instructions cause CPU 501 to execute the steps included in the above methods. The input/output (I/O) interface 505 is also coupled to the bus 504. The communication part 512 may be integrally arranged, or may be arranged to have a plurality of sub-modules (for example, a plurality of IB network cards) and be linked to the bus.

The following components are connected to the I/O interface 505: an input component 506 including a keyboard, a mouse, etc; an output component 507 including, for example, a cathode ray tube (CRT), a liquid crystal display (LCD), a speaker and the like; a storage component 508 including a hard disk or the like; and a communication component 509 including a network interface card such as a local area network (LAN) card, a modem or the like. The communication component 509 performs communication processing via a network such as Internet. The driver 510 is also connected to I/O interface 505 as needed. A removable medium 511, such as a magnetic disk, an optical disk, a magneto-optical disk, a semiconductor memory, or the like, is mounted on the driver 510 as needed, so that a computer program read out from the removable medium 511 is mounted in the storage component 508 as needed In.

It should be noted that the architecture illustrated in FIG. 5 is just an optional implementation, and in the specific practice process, the number and the types of components in FIG. 5 can be selected, deleted, added or replaced according to actual requirements; for different functional components, they may be implemented in a separate manner or in an integrated manner. For example, the GPU 513 and the CPU 501 can be provided separately or the GPU 513 can be integrated on the CPU 501, the communication component can be provided separately or integrated on the CPU 501 or GPU 513, and so on. All the alternative embodiments fall into the protection scope of the present disclosure.

In particular, according to the embodiments of the present disclosure, the process described below with reference to the flowcharts can be implemented as a computer software program. For example, the embodiments of the present disclosure include a computer program product, which includes a computer program product tangibly contained on a machine-readable medium. The computer program includes program code for executing the steps shown in the flowchart, and the program code may include instructions corresponding to the steps in the method provided by the present disclosure.

In such embodiments, the computer program may be downloaded and installed from the network through the communication component 509 and/or installed from the removable medium 511. When the computer program is executed by CPU 501, the instructions for implementing the methods in of the present disclosure are executed.

In one or more optional implementation manners, the embodiments of the present disclosure also provide a computer program product for storing computer-readable instructions, which when executed, cause a computer to execute the method of controlling image acquisition or neural network training method described in any one of the above-mentioned embodiments.

The computer program product can be implemented specifically by hardware, software or a combination thereof. In an optional example, the computer program product is embodied as a computer storage medium. In another optional example, the computer program product is embodied as a software product, such as a Software Development Kit (SDK) and so on.

In one or more optional implementations, the embodiments of the present disclosure further provide another method of controlling image acquisition and neural network training method and corresponding apparatus and electronic device, computer storage medium, computer program, and computer program product, where the method includes that: a first apparatus sends an instruction of controlling image acquisition or training a neural network to a second apparatus, which causes the second apparatus to execute the method of controlling image acquisition and neural network training method in any one of the above possible embodiments; the first apparatus receives the processing result of controlling image acquisition and training the neural network sent by the second apparatus.

In some embodiments, the instruction of controlling image acquisition or training a neural network may be specific a calling instruction, and the first apparatus may instruct the second apparatus to perform the controlling of image acquisition and the training of the neural network. Accordingly, in response to receiving the calling instruction, the second apparatus may execute steps and/or processes of the method of controlling image acquisition and neural network training method in any one of the above embodiments.

It should be understood that terms such as “first” and “second” in the embodiments of the present disclosure are merely for distinguishing, and should not be construed as limiting the embodiments of the present disclosure. It should also be understood that in the present disclosure, “a plurality of” may refer to two or more, and “at least one” may refer to one, two or more. It should also be understood that any one of the components, data or structures mentioned in the present disclosure may generally be understood as one or more of the components, data or structures without expressly defining or giving the opposite motivation in the context. It should also be understood that the description of various embodiments of the present disclosure focuses on emphasizing differences between various embodiments, and the same or similar points may be referred to each other. For simplicity, the same or similar parts will not be described herein again.

The method, apparatus, electronic device and computer-readable storage medium in the present disclosure are implemented in many manners. For example, the method, apparatus, electronic device and computer-readable storage medium in the present disclosure may be implemented with software, hardware, firmware, or any combination of software, hardware, and firmware. The above-mentioned sequence of the steps of the method is for illustration only, and the steps of the method of the present disclosure are not limited to sequence specifically described above, unless otherwise specified. In addition, in some embodiments, the present disclosure may further be implemented as programs recorded in a recording medium, and these programs include machine-readable instructions for implementing the method according to the present disclosure. Thus, the present disclosure further covers a recording medium storing a program for executing the method according to the present disclosure.

The description of the present disclosure is provided for the sake of illustration and description, rather than for exhausting the embodiments of the present disclosure or limiting the present disclosure to what is disclosed. Many modifications and variants, are obvious to one of ordinary skill in the art. The embodiments are selected and described to better illustrate implementations principles and practical applications of the present disclosure, and to enable one of ordinary skill in the art to understand the embodiments of the present disclosure so as to design various embodiments with various modifications suitable for specific purposes.

1. A computer-implemented method of controlling image acquisition, comprising:
providing a first image sample set to a first neural network;
selecting one or more first hard samples from the first image sample set according to a processing result of the first neural network for each first image sample in the first image sample set;
determining acquisition environment information of the one or more first hard samples based on the one or more first hard samples selected from the first image sample set; and
generating, according to the acquisition environment information, image acquisition control information for instruction of an acquisition of a second image sample set comprising one or more second hard samples.

2. The computer-implemented method of claim 1, wherein the first image sample set comprises a first image sample without label information.

3. The computer-implemented method of claim 2, wherein selecting the one or more first hard samples from the first image sample set according to the processing result of the first neural network for each first image sample in the first image sample comprises:
detecting whether the processing result of the first neural network for each first image sample in the first image sample set is incorrect; and
determining a first hard sample according to a first image sample corresponding to an incorrect processing result of the first neural network for the first image sample.

4. The computer-implemented method of claim 3, wherein the first image sample set comprises a plurality of video frame samples consecutive in a time sequence, and
wherein detecting whether the processing result of the first neural network for each first image sample in the first image sample set is incorrect comprises:
performing a target object continuity detection on respective target object detection results output by the first neural network for the plurality of video frame samples, and
detecting whether a processing result of the first neural network for a video frame sample is incorrect by determining whether the respective target object detection result corresponding to the video frame sample fails to meet a preset continuity requirement.

5. The computer-implemented method of claim 3, further comprising:
providing the first image sample set to a second neural network,
wherein detecting whether the processing result of the first neural network for each first image sample in the first image sample set is incorrect comprises:
determining a difference between a first processing result of the first neural network for the first image sample and a second processing result of the second neural network for the first image sample; and
detecting whether the first processing result of the first neural network for the first image sample is incorrect by determining that the difference fails to meet a preset difference requirement.

6. The computer-implemented method of claim 3, wherein determining the first hard sample according to the first image sample corresponding to the incorrect processing result of the first neural network for the first image sample comprises:
obtaining an error type of the incorrect processing result; and
in response to determining that the error type of the incorrect processing result is a neural network processing error, determining the first image sample as the first hard sample.

7. The computer-implemented method of claim 6, wherein the first neural network is configured to detect a target object in the first image sample, and
wherein the computer-implemented method further comprises:
in response to determining that the error type of the incorrect processing result indicates that a target object bounding box obtained by the first neural network performing a detection on the first image sample is incorrect, adjusting a module that is included in the first neural network and configured to detect the target object bounding box.

8. The computer-implemented method of claim 6, further comprising:
in response to determining that the error type of the incorrect processing result is associated with a factor of camera device, sending promotion information of changing the camera device.

9. The computer-implemented method of claim 1, wherein the acquisition environment information comprises at least one of: road section information, weather information, or light intensity information.

10. The computer-implemented method of claim 9, wherein the acquisition environment information comprises the road section information, and
wherein generating the image acquisition control information according to the acquisition environment information comprises:
determining an acquisition road section matching the one or more first hard samples based on the road section information;
generating a data acquisition path with the determined acquisition road section; and
generating the image acquisition control information including the data acquisition path for instruction of a camera device to acquire the second image set according to the data acquisition path.

11. The computer-implemented method of claim 1, further comprising:
adding the one or more first hard samples to a training sample set; and
obtaining an adjusted first neural network by training the first neural network with the training sample set.

12. The computer-implemented method of claim 11, wherein each of the one or more first hard samples is with corresponding label information, and
wherein obtaining the adjusted first neural network by training the first neural network with the training sample set comprises:
providing the one or more first hard samples in the training sample set to the first neural network; and
obtaining the adjusted first neural network by adjusting at least one parameter of the first neural network according to a difference between a processing result of the first neural network for each of the one or more first hard samples and the corresponding label information.

13. The computer-implemented method of claim 11, further comprising:
obtaining the second image sample set;
providing the second image sample set to the adjusted first neural network; and
selecting the one or more second hard samples from the second image sample set according to a processing result of the adjusted first neural network for each second image sample in the second image sample set.

14. An apparatus, comprising:
at least one processor; and
one or more memories coupled to the at least one processor and storing programming instructions for execution by the at least one processor to perform operations comprising:
providing a first image sample set to a first neural network;
selecting one or more first hard samples from the first image sample set according to a processing result of the first neural network for each first image sample in the first image sample set;
determining acquisition environment information of the one or more first hard samples based on the one or more first hard samples; and
generating, according to the acquisition environment information, image acquisition control information for instruction of an acquisition of a second image sample set comprising one or more second hard samples.

15. The apparatus of claim 14, wherein the first image sample set comprises a first image sample without label information.

16. The apparatus of claim 15, wherein selecting the one or more first hard samples from the first image sample set according to the processing result of the first neural network for each first image sample in the first image sample comprises:
detecting whether the processing result of the first neural network for each first image sample in the first image sample set is correct or not;
determining a first hard sample according to a first image sample corresponding to an incorrect processing result of the first neural network for the first image sample.

17. The apparatus of claim 16, wherein the first image sample set comprises a plurality of video frame samples consecutive in a time sequence, and
wherein detecting whether the processing result of the first neural network for each first image sample in the first image sample set is correct or not comprises:
performing a target object continuity detection on respective target object detection results output by the first neural network for the plurality of video frame samples, and
detecting whether a processing result of the first neural network for a video frame sample is incorrect by determining whether the respective target object detection result corresponding to the video frame sample fails to meet a preset continuity requirement.

18. The apparatus of claim 16, wherein the operations further comprising:
providing the first image sample set to a second neural network,
wherein detecting whether the processing result of the first neural network for each first image sample in the first image sample set is incorrect comprises:
determining a difference between a first processing result of the first neural network for the first image sample and a second processing result of the second neural network for the first image sample; and
detecting whether the first processing result of the first neural network for the first image sample is incorrect by determining that the difference fails to meet a preset difference requirement.

19. The apparatus of claim 16, wherein determining the first hard sample according to the first image sample corresponding to the incorrect processing result of the first neural network for the first image sample comprises:
obtaining an error type of the incorrect processing result; and
in response to determining that the error type of the incorrect processing result is a neural network processing error, determining the first image sample as the first hard sample.

20. A non-transitory computer readable storage medium coupled to at least one processor and having machine-executable instructions stored thereon that, when executed by the at least one processor, cause the at least one processor to perform operations comprising:
providing a first image sample set to a first neural network;
selecting one or more first hard samples from the first image sample set according to a processing result of the first neural network for each first image sample in the first image sample set;
determining acquisition environment information of the one or more first hard samples based on the one or more first hard samples selected from the first image sample set; and
generating, according to the acquisition environment information, image acquisition control information for instruction of an acquisition of a second image sample set comprising one or more second hard samples.
